(19) United States
(12) Patent Application Publication
(10) Pub. No.: US 2025/0383486 A1
(43) Pub. Date: Dec. 18, 2025

(54) HOLOGRAPHIC METASURFACE GRATING ELEMENTS FOR AUGMENTED AND VIRTUAL REALITY

(71) Applicant: THE REGENTS OF THE UNIVERSITY OF CALIFORNIA, Oakland, CA (US)

(72) Inventors: Hyunpil BOO, Los Angeles, CA (US); Hangbo YANG, Los Angeles, CA (US); Chee Wei WONG, Los Angeles, CA (US); Yoo Seung LEE, Los Angeles, CA (US)

(73) Assignee: THE REGENTS OF THE UNIVERSITY OF CALIFORNIA, Oakland, CA (US)

(21) Appl. No.: 18/875,016

(22) PCT Filed: Jun. 16, 2023
(86) PCT No.: PCT/US2023/068622

§ 371 Date: Dec. 13, 2024

Related U.S. Application Data
(60) Provisional application No. 63/353,493, filed on Jun. 17, 2022.

(51) Int. Cl. G02B 5/18; G02B 27/42

(52) U.S. Cl. CPC G02B 5/1866; G02B 27/4205; G02B 27/4272

(57) ABSTRACT

The present disclosure relates to highly efficient curved holographic aligned nonlinear grating elements (CHANGE) for high-resolution high-performance augmented and virtual reality. In embodiments, a curved shape can be designed by input angle and output angle for each position of the CHANGE. Each position has a different grating direction (x) and a different period. For AR devices, two-dimensional image sources from the displays can be used. Thus, CHANGES can be applied for both in-coupling and out-coupling diffractive metasurface optical elements (MOEs) instead of using a two-dimensional grating. In the in-coupling MOE region, collimated display input source can be diffracted and guided into waveguide glass and magnified for both of the two-dimensional directions at the out-coupling region by using in-coupling CHANGE. In an out-coupling MOE region, a magnified two-dimensional image is focused at the eyebox by using out-coupling CHANGE. Thus, using CHANGE components according to embodiments, various sizes of input two-dimensional image sources can be converted to target sizes of two-dimensional images at the eyebox with high efficiency.

### CROSS REFERENCE TO RELATED APPLICATIONS

The present application claims priority to U.S. Provisional Patent Application No. 63/353,493 filed Jun. 17, 2022, the contents of which are incorporated herein by reference in their entirety.

### TECHNICAL FIELD

The present embodiments relate generally to augmented and virtual reality and more particularly to holographic grating elements for augmented and virtual reality applications.

### BACKGROUND

Virtual reality (VR) and augmented reality (AR) applications (e.g. gaming, simulators, trainers, etc.) are becoming increasingly popular. In VR, the users' perception of reality is completely based on virtual information. In AR, the user is provided with additional computer-generated information within the data collected from real life that enhances their perception of reality. Accordingly, AR differs from VR in the sense that in AR part of the surrounding environment is “real” and AR is just adding layers of virtual objects to the real environment. On the other hand, in VR the surrounding environment is completely virtual and computer generated.

VR and AR applications are typically built on sophisticated software and hardware platforms. For example, VR and AR applications typically include a processor, display, sensors and input devices. Modern mobile computing devices like smartphones and tablet computers contain these elements, which often include a camera and microelectromechanical systems (MEMS) sensors such as an accelerometer, GPS, and a solid state compass, making them suitable AR platforms.

Two technologies that are typically used for display devices in AR applications include diffractive waveguides and reflective waveguides. In such applications, the display devices (e.g. including one or more eyeboxes) typically use glass waveguides with holographic optical elements (HOEs) or metasurface optical elements (MOEs) so that the size and cost of them are reduced. The design of these display device structures is often complicated and made challenging with various trade-offs such as performance and efficiency.

It is against this technological backdrop that the present Applicant sought a technological solution to these and other problems rooted in this technology.

### SUMMARY

The present embodiments relate to highly efficient curved holographic aligned nonlinear grating elements (CHANGE) for high-resolution high-performance augmented and virtual reality. Embodiments include a one-dimensional grating with a curved shape which has a high diffraction efficiency, but for the diffraction angle, it has a two-dimensional degree of freedom. The two orthogonal diffraction angles are similar to a two-dimensional grating which has low efficiency. The curved shape can be designed by input angle and output angle for each position of the CHANGE. Each position has a different grating array direction and a different period. For AR devices, two-dimensional image sources from the displays can be used. CHANGEs according to embodiments can be applied for both in-coupling and out-coupling diffractive metasurface optical elements (MOEs) instead of a two-dimensional grating. In the in-coupling MOE region, a collimated display input source can be diffracted and guided into waveguide glass and magnified for both of the two-dimensional directions at the out-coupling region by using in-coupling CHANGE. In an out-coupling MOE region, a magnified two-dimensional image is focused at an eyebox by using out-coupling CHANGE. Thus, using CHANGE components according to embodiments, various sizes of input two-dimensional image sources can be converted to a target size of a two-dimensional image at the eyebox with high efficiency.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIGS. 1(a) and 1(b) are diagrams illustrating an example diffraction coordinate system of CHANGE according embodiments. FIG. 1(b) illustrates the incident wavevector of incident field (I0) and the reflective (R) and the mirrored transmitted (T) diffractions in x-y-z space. FIG. 1(b) is a top view of the x-y plane of FIG. 1(a) showing different array direction angles of the grating structure with the numbered points for intersection points of each diffraction.

FIGS. 2(a), 2(b) and 2(c) illustrate example aspects of CHANGE for R, G, and B wavelength components, respectively.

FIGS. 3(a) and 3(b) are functional block diagrams illustrating an example overall architecture of a baseline CMOS-compatible waveguide display according to embodiments.

FIGS. 4(a) and 4(b) illustrate an example prototype design and demonstration unit according to embodiments.

FIG. 5 illustrates aspects of an example cascaded structure for CHANGE according to embodiments. It includes a combination of each of the CHANGE lines for red, blue and green. The grating structures are divided to small parts for a specific amount in the y direction and at each point these parts are combined in the same order RGB. As a result all three wavelengths will be diffracted to the specific input and output angles.

FIGS. 6(a), 6(b) and 6(c) illustrate an example SEM picture and the design of a cascaded CHANGE according to embodiments. In this example a fabricated CHANGE structure includes a cascade of 300 nm.

FIG. 7 illustrates aspects of cascaded CHANGE for color balance correction according to embodiments. It consists of cascaded structures with the size of each cascaded line is different for each color. The size difference of the cascade is being used to correct for the color nonuniformity in the display image source of the different efficiency for each color.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

The present disclosure presents curved holographic aligned nonlinear grating elements (CHANGE) which diffracts the light off-plane but is still a one-dimensional grating structure and thus has an efficiency greater than two-dimensional grating structures. The grating vector in CHANGE is off-plane and at each position, the grating vector and the period can be designed based on the input angle and output angle. The design can change based on the wavelength since the required grating vector and period is dependent on the wavelength. For each wavelength to be diffracted in the same direction or in each required direction, HOEs or MOEs can incorporate each wavelength with matching designs. (H. Mukawa, K. Akutsu, I. Matsumura, S. Nakano, T. Yoshida, M. Kuwahara, and K. Aiki, “A full color eyewear display using planar waveguides with reflection volume holograms,” J. Soc. Inf. Disp. 17, 185-193 (2009); B. C. Kress and M. Shin, “Diffractive and holographic optics as optical combiners in head mounted displays,” presented at Ubicomp, Wearable Systems for Industrial Augmented Reality Applications, Zurich, Switzerland, 8-12 Sep. 2013; L. Eisen, M. Meyklyar, M. Golub, A. A. Friesem, I. Gurwich, and V. Weiss, “Planar configuration for image projection,” Appl. Opt. 45, 4005-4011 (2006); A. Cameron, “The application of holographic optical waveguide technology to Q-sight family of helmet mounted displays,” Proc. SPIE 7326, 1-11 (2009); J. Guo, Y. Tu, L. Yang, L. Wang, and B. Wang, “Design of a multiplexing grating for color holographic waveguide,” Opt. Eng. 54, 125105 (2015); Z. Wu, J. Liu, and Y. Wang, “A high-efficiency holographic waveguide display system with a prism in-coupler,” J. Soc. Inf. Disp. 21, 524-528 (2013); Kämpfe T, Kley EB, Tünnermann A, Dannberg P, “Design and fabrication of stacked, computer generated holograms for multicolor image generation,” Appl. Opt. 46, 5482-5488 (2007)). This can be done in multiple methods, including multiple layers with each layer for a single wavelength or a single layer with cascaded grating structures as in the design explained below.

As set forth above, AR devices typically use glass waveguides with HOEs (holographic optical elements) or MOEs (metasurface optical elements) to achieve desired size and cost reductions. These HOEs or MOEs can be made of various diffraction grating structures such as Bragg grating, volume grating, surface relief grating, blazed grating, etc. using materials and methods known to those skilled in the art. (E.g. Mool C. Gupta and S. T. Peng, “Diffraction characteristics of surface-relief gratings,” Appl. Opt., vol. 32, 2911-2917 (1993); C. Kwan, G. W. Taylor, “Optimization of the parallelogrammic grating diffraction efficiency for normally incident waves,” Applied Optics, vol. 37, 7698-7707 (1998); M. G. Moharam, T. K. Gaylord, “Diffraction analysis of dielectric surface-relief gratings”, J. Opt. Soc. Am. A, vol. 72, 1385-1392 (1982); T. W. Preist, J. B. Harris, N. P. Wanstall, J. R. Sambles, “Optical response of blazed and overhanging gratings using oblique Chandezon transformations,” J. Mod. Opt., vol. 44, 1073-1080 (1997); K. Yokomori, “Diclectric surface-relief gratings with high diffraction efficiencies,” Appl. Opt., vol. 23, 2303-2310 (1984); A. V. Tishchenko, “Phenomenological representation of deep and high contrast lamellar gratings by means of the modal method,” Opt. Quantum Electron., vol. 37, 309-330 (2005); T. Clausnitzer, T. Kämpfe, E.-B. Kley, A. Tünnermann, U. Peschel, A. V. Tishchenko, and O. Parriaux, “An intelligible explanation of highly-efficient diffraction in deep dielectric rectangular transmission gratings,” Opt. Express, vol. 13, 10448 (2005); J. Zheng, C. Zhou, J. Feng, and B. Wang, “Polarizing beam splitter of deep-etched triangular-groove fused-silica gratings,” Opt. Lett., vol. 33, 1554 (2008); J. A. Arns, W. S. Colburn, and S. C. Barden, “Volume phase gratings and their potentials for astronomical applications,” Proc. SPIE 3355, 866-876 (1998); B. P. Blanche, P. Gailly, S. Habraken, P. Lemaire, and C. Jamar, “Volume phase holographic gratings: large size and high diffraction efficiency,” Opt. Eng. 43, 2603-2612 (2004)). As such, further details regarding such materials and methods will be omitted here for sake of clarity of the present embodiments.

Such MOEs or HOEs are most usually operated in a single plane consisting of the wavevector of the incident field and the normal to the grating surface. In this case, if the grating structure vector is within this plane, all diffracting orders will be in-plane. However, in AR display devices, some designs require the light to be diffracted off-plane, as in the case where the light must be focused to the eyebox. In such cases where off-plane diffraction is required, two-dimensional grating structures can be used. For these two-dimensional grating structures to diffract off-plane, usually the diffracting gratings have two grating vectors, with one being in-plane and the other being orthogonal to in-plane. However, efficiency drops considerably with these two-dimensional grating structures because the light is being diffracted in two directions at the same time. (C. C. Braig, L. Fritzsch, T. K″asebier, E.-B. Kley, C. Laubis, Y. Liu, F. Scholze, and A. T″unnermann, “An EUV beamsplitter based on conical grazing incidence diffraction”, Optics Express, Vol. 20, Issue 2, pp. 1825-1838 (2012); M. G. Moharam, Eric B. Grann, and Drew A. Pommet, “Formulation for stable and efficient implementation of the rigorous coupled-wave analysis of binary gratings”, J. Opt. Soc. Am. A, Vol. 12, Issue 5, pp. 1068-1076 (1995); C. Wan, T. K. Gaylord, and M. S. Bakir, “Rigorous coupled-wave analysis equivalent-index-slab method for analyzing 3D angular misalignment in interlayer grating couplers”, Applied Optics Vol. 55, Issue 35, pp. 10006-10015 (2016); C. Wan, T. K. Gaylord, and M. S. Bakir, “Grating design for interlayer optical interconnection of in-plane waveguides”, Applied Optics Vol. 55, Issue 10, pp. 2601-2610 (2016); R. Allured, R. T. McEntaffer, “Analytical alignment tolerances for off-plane reflection grating spectroscopy”, Experimental Astronomy, Vol. 36, Issue 3, pp 661-677 (2013)).

In accordance with general aspects, the present embodiments relate to Curved Holographic Aligned Nonlinear Grating Elements (CHANGE).

In a first example, diffraction angles of the one-dimensional linear grating depend on the incident angle, period of grating, wavelength, and material refractive index.

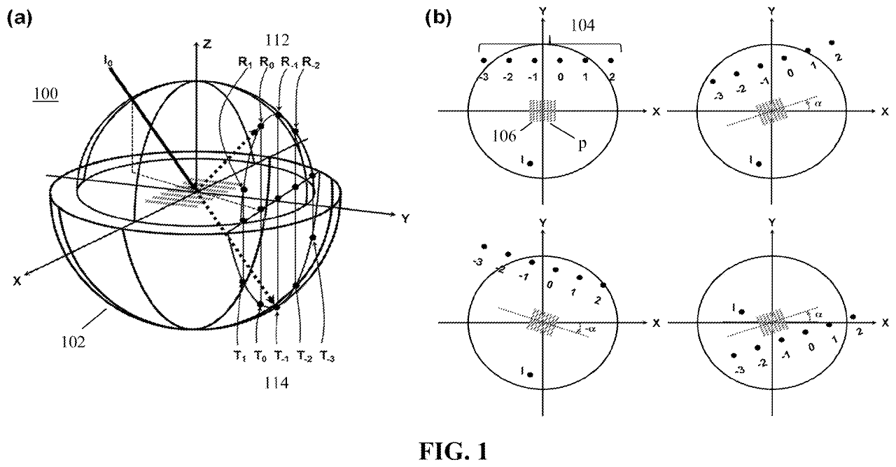

FIG. 1(a) shows a grating coordinate system 100 which represents grating array direction, incident angle, multimode reflection diffraction angles and transmission diffraction angles in accordance with embodiments. The radius of sphere 102 is decided by the refractive index of the medium. R and T are reflection grating orders and transmission grating orders, respectively. As can be seen in the example of FIG. 1(a), the positions of reflection grating orders 112 and the transmission grating orders 114 are mirrored by the x-y plane.

FIG. 1(b) is a look down view along the z-axis and diffraction orders 104 from −3 to 2 are parallel to grating array direction (a), with four different examples of grating array 106 direction shown. Distance between adjacent diffraction orders in 104 is decided by grating period. Finally, for arbitrary incident angle (with respect to I), output diffraction angles can be controlled by changing grating period (p) and grating array direction (a). Simultaneously, while the output diffraction angle is controlled by the period and array direction, the fill factor and the height of the grating is free to be chosen separately. The fill factor and the height will impact the efficiency of the diffractions. The plane where the grating structure 106 is located can also be rotated so that the plane is at a certain angle, instead of the incident light coming in from a certain angle. This tool can be used in both the in-couple and out-couple gratings and enables the user to actively control where the light diffracts to without using low efficiency two-dimensional gratings. Although throughout this work the grating structures were chosen to be SiNx single layers, they do not have to be SiNx and also do not have to be singular layers.

In the above and other embodiments, CHANGE can be made by continuously changing a grating period and an array direction for each position. Grating period and array direction can be designed by both input angle and output angle for each position. For each position, grating is like a one-dimensional grating. But diffraction output angle can be designed for both x-direction and y-direction like a two-dimensional grating. Generally, a two-dimensional grating has both x and y direction diffraction orders. So, there exists much higher diffraction orders compared to one-dimensional grating since diffraction order of two-dimensional grating can be multiplied by x orders and y orders. Thus, two-dimensional gratings have much lower efficiency than one-dimensional gratings. However, CHANGE has only one direction diffraction order which has very high efficiency and both x and y direction diffraction angles. The grating structures can also incorporate slanted angle gratings to increase efficiency even higher. (J. M. Miller, N. de Beaucoudrey, P. Chavel, J. Turunen, and E. Cambril, “Design and fabrication of binary slanted surface-relief gratings for a planar optical interconnection,” Appl. Opt. 36, 5717-5727 (1997); J. S. Maikisch and T. K. Gaylord, “Optimum parallel-face slanted surface-relief gratings,” Appl. Opt. 46, 3674-3681 (2007); T. Levola and P. Laakkonen, “Replicated slanted gratings with a high refractive index material for in and outcoupling of light,” Opt. Express 15, 2067-2074 (2007); S. Li, C. Zhou, H. Cao, and J. Wu, “Simple design of slanted grating with simplified modal method,” Opt. Lett. 39, 781-784 (2014)).

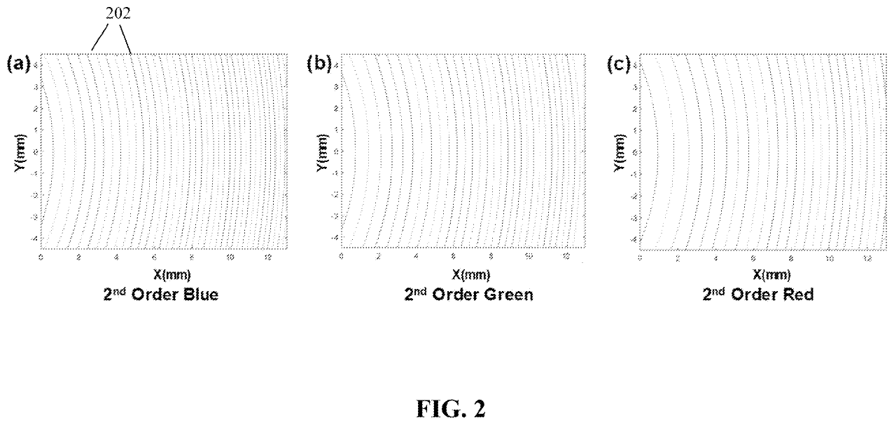

FIGS. 2(a), 2(b) and 2(c) show the top view of an example outcoupling grating structure with second order CHANGE for blue, green and red wavelengths, respectively. In this specific design, the light is coming in from the left side and the outcoupling grating focuses the light into the eye box. This specific design comprises a 13 mm×9 mm structure for each wavelength, but CHANGE can accommodate various designs. Each of the figures describes the 1000th line and as can be seen, the design for the blue (FIG. 2(a)) has lines 202 that are tightly spaced since the wavelength of blue is smallest.

As can be seen, the curvature and the spacing between the lines 202 change with each position within the structure in all three designs. The curvature is greatest in the left side and flattens out in the right side for this specific design. Put another way, for each position in x and y, the pitch between lines 202 and the array direction of each line 202 is variable. In this example, as x increases, the pitch becomes smaller. With respect to y, around y=0, the array direction is around 0, but the array direction (α as shown in FIG. 1(b)) becomes increasingly non-zero as y increases, which leads to the curved shape of lines 202 according to aspects of embodiments.

In other designs, this change in curvature and spacing can be altered to accommodate different input and output angles of light. The same goes for the periods and hence the spacing between the lines in the figure. (H. Kogelnik, “Coupled-wave theory of thick hologram gratings,” Bell Syst. Tech. J. 48, 2909-2947 (1969); M. G. Moharam and T. K. Gaylord, “Rigorous coupled-wave analysis of planar-grating diffraction,” J. Opt. Soc. Am. 71, 811-818 (1981); M. G. Moharam, D. A. Pommet, E. B. Grann, and T. K. Gaylord, “Stable implementation of the rigorous coupled wave analysis for surface-relief dieletric gratings: enhanced transmittance matrix approach,” J. Opt. Soc. Am. A 12, 1077-1086 (1995)).

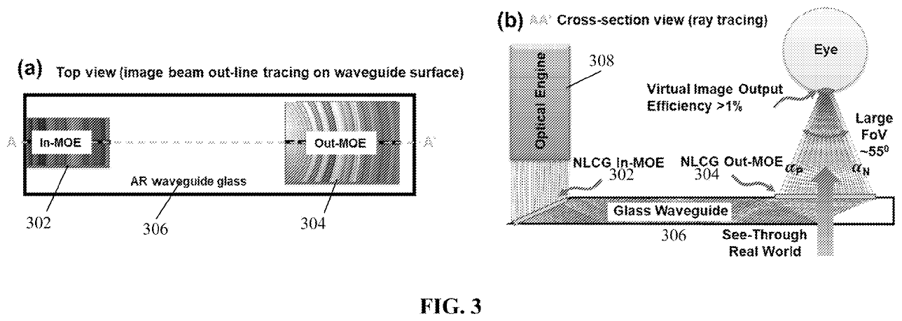

FIGS. 3(a) and 3(b) show aspects of an example waveguide display with in-coupling and out-coupling CHANGE for augmented reality devices according to embodiments. As shown in FIG. 3(a), in-coupling CHANGE 302 can transfer and transform an incoming image (e.g. an expanded collimated beam from three color lasers serving as the display input) to an out-coupling region. Then, out-coupling CHANGE 304 can focus the image to the eyebox as shown in FIG. 3(b). The light in between the in-coupling CHANGE and the out-coupling CHANGE is total internally reflected within the waveguide 306, which is 3 mm in the shown example, but can become thinner or thicker. The figure also shows the in-coupling CHANGE 302 to be smaller than the out-coupling CHANGE 304, but this is also a design aspect and CHANGE can accommodate multiple designs. The figure also shows the in-coupling grating to be flat on the waveguide 306, but this can be tilted, such as with the grating on a prism like surface or with the waveguide cut at angle. Although CHANGE does not require the beam to collimated or perpendicular as long as the beam comes in at a fixed angle, the design shown in the figure shows a collimated perpendicular light source 308.

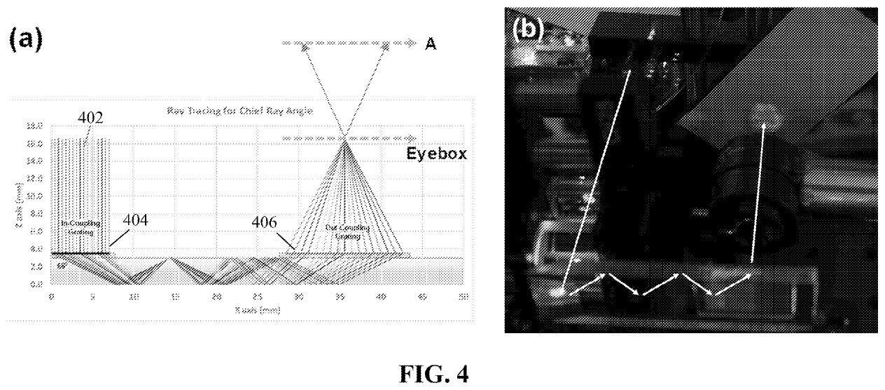

FIG. 4(a) represents an example prototype ray design with ray tracing method according to embodiments. An incoming image beam 402 is collimated and perpendicular to an in-coupling CHANGE 404 in this design. In-coupling CHANGE 404 is a kind of chirped grating in which diffraction angle is continuously changed as a function of the position. In this in-coupling CHANGE 404, the in-coupling image is magnified in the x direction at the out-coupling region 406. The y dimension remains constant in both the in-coupling and out-coupling as 9 mm in this design.

FIG. 4(b) is a photograph illustrating an example demonstration of a prototype waveguide display using CHANGE according to embodiments. An image including letters A and B has been guided inside the waveguide glass and projected at the output screen. The position A, where the image is projected is further away than the eye-box so that the letters can be seen with the naked eye. Although the letter is rotated in the result, this can be altered.

In accordance with additional or alternative aspects, the present embodiments relate to Cascaded CHANGE. In one example in accordance with these embodiments, cascaded CHANGE is implemented for a multiwavelength source.

In particular, single layer grating is a common design for a single wavelength since diffraction angle is decided by wavelength, grating period, input angle, grating array direction, refractive index of both input and output medium. In order to generate a full color image, one needs to use a RGB light source for the display. Thus, conventional waveguide displays use three different MOE layers for R, G, and B respectively. In accordance with the present embodiments, however, these three different MOEs can be combined together in a single layer using a cascade method. Thus, nonlinear curved MOEs for each wavelength can be combined in a single layer as well. This is the multiwavelength cascaded nonlinear curved MOE which can applied to both of in-coupling MOE and out-coupling MOE.

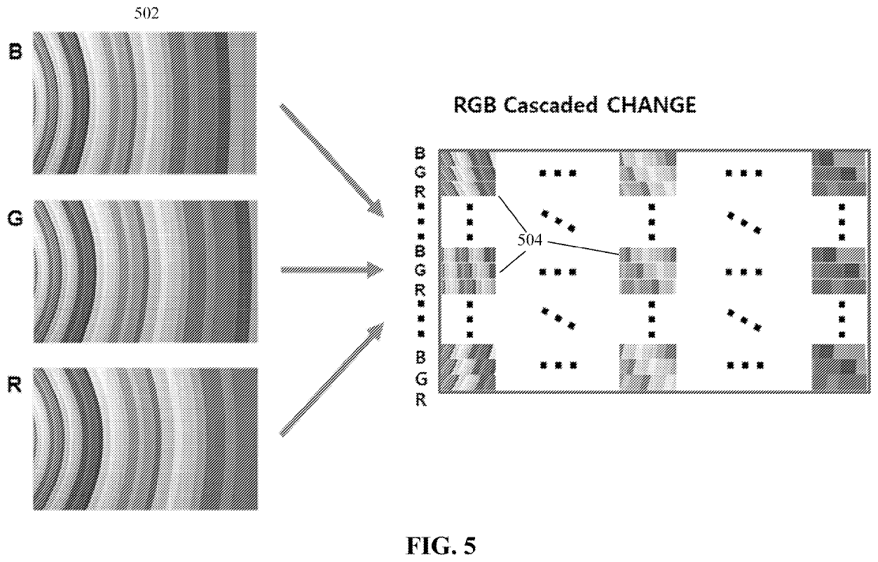

FIG. 5 illustrates example schematics of a cascaded structure for CHANGE according to embodiments. It consists of combination of each of the CHANGE lines for red, blue and green. The grating structures 502 are divided to small parts 504 for a specific amount in the y direction and at each point these parts are combined in the same order RGB. As a result, all three wavelengths will be diffracted to the specific input and output angles.

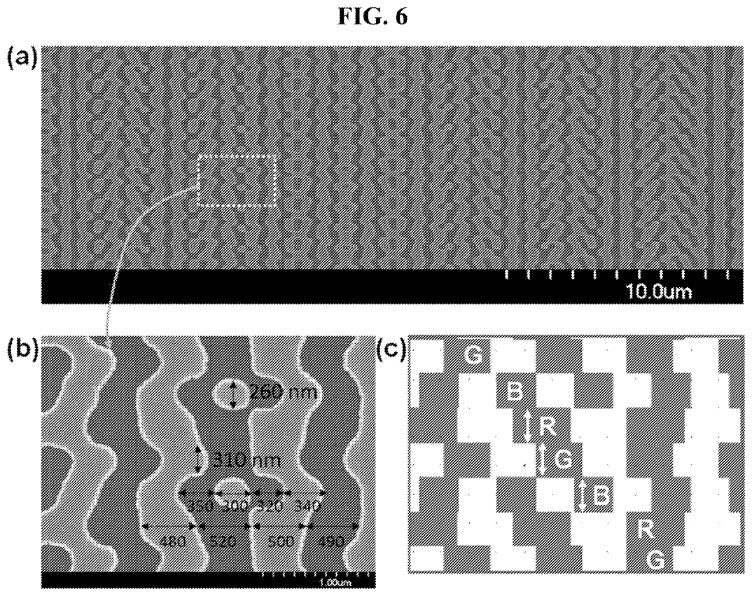

FIGS. 6(a), 6(b) and 6(c) illustrate an example SEM picture and the design of cascaded CHANGE in accordance with embodiments. It consists of the fabricated cascaded CHANGE structure where the cascade was to be 300 nm. As shown in the SEM picture in FIGS. 6(a) and 6(b) and the design in FIG. 6(c), the periods for each red, blue and green lines are different with the red being the largest.

Cascaded CHANGE can also be implemented for color balance correction. For example, for a color display source, color nonuniformity can occur from the display image source as a result of the different efficiency of each color CHANGE MOE. This color nonuniformity could be different for each position of the CHANGE MOE region. Color nonuniformity can be adjusted by changing a ratio of the cascade size. One can also change cascade size continuously for all positions of the CHANGE MOE region. Then, all image area could have uniform color balance.

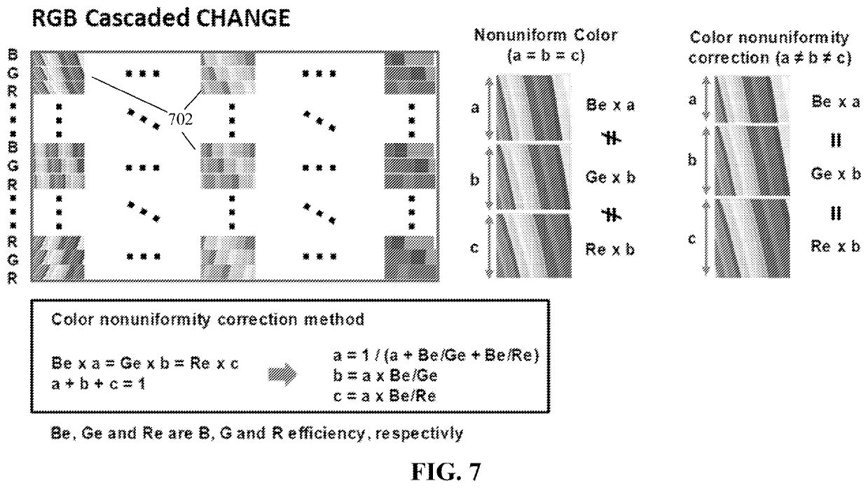

FIG. 7 illustrates aspects of Cascaded CHANGE for color balance correction according to embodiments. It consists of cascaded structures 702 wherein the size of each cascaded line is different for each color. The size difference of the cascade is being used to correct for the color nonuniformity in the display image source of the different efficiency for each color.

Color nonuniformity can be also adjusted using color balance from the source of the image. By balancing the red intensity of the image, the output of the image can be tuned. This can be used in addition to the color balance correction from the MOE shown above. The ratio of the color balance from the source could be for a single color or for all three colors simultaneously. This color balance can also be differentiated based on position in the image.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

1. An apparatus for highly efficient curved holographic aligned nonlinear grating elements (CHANGE) for high-resolution high-performance augmented and virtual reality comprising:
a curved shape 1-dimensional grating configured to produce diffraction of an incident source with a 2-dimensional degree of freedom including two orthogonal diffraction angles.

2. The apparatus of claim 1, wherein the curved shape is configured in accordance with an input angle of the incident source and output angle of the diffraction for each position of the CHANGE.

3. The apparatus of claim 2, wherein each position has different grating direction (x) and different period.

4. The apparatus of claim 1, comprising two of the curved shape 1-dimensional grating, wherein one of the two curved shape 1-dimensional gratings is configured as an in-coupling diffractive metasurface optical element (MOE) and the other of the two curved shape 1-dimensional gratings is configured as an out-coupling diffractive MOE.

5. The apparatus of claim 4, wherein the in-coupling diffractive MOE, is configured to receive and diffract a collimated display input source and to guide the input source into waveguide glass, and wherein the out-coupling diffractive MOE is configured to magnify the input source for both 2-dimensional directions.

6. The apparatus of claim 5, wherein the out-coupling diffractive MOE, is configured to provide a magnified 2D image at an external eyebox.

7. An apparatus for highly efficient curved holographic aligned nonlinear grating elements (CHANGE) for high-resolution high-performance augmented and virtual reality comprising:
a plurality of the curved shape 1-dimensional gratings of claim 1 that are cascaded and configured for a multiwavelength source.

8. A method for highly efficient curved holographic aligned nonlinear grating elements (CHANGE) for high-resolution high-performance augmented and virtual reality comprising:
configuring a curved shape 1-dimensional grating to produce diffraction of an incident source with a 2-dimensional degree of freedom including two orthogonal diffraction angles.

9. The method of claim 8, wherein configuring includes configuring the curved shape in accordance with an input angle of the incident source and output angle of the diffraction for each position of the CHANGE.

10. The method of claim 9, wherein each position has different grating direction (x) and different period.

11. The method of claim 8, comprising two of the curved shape 1-dimensional grating, wherein configuring includes configuring one of the two curved shape 1-dimensional gratings as an in-coupling diffractive metasurface optical element (MOE) and configuring the other of the two curved shape 1-dimensional gratings as an out-coupling diffractive MOE.

12. The method of claim 11, wherein the in-coupling diffractive MOE is configured to receive and diffract a collimated display input source and to guide the input source into waveguide glass, and wherein the out-coupling diffractive MOE is configured to magnify the input source for both 2-dimensional directions.

13. The method of claim 12, wherein the out-coupling diffractive MOE is configured to provide a magnified 2D image at an external eyebox.
